(19) United States
(12) Patent Application Publication
(10) Pub. No.: US 2002/0123254 A1
(43) Pub. Date: Sep. 5, 2002

(54) Connector having signal contacts and ground contacts in a specific arrangement

(76) Inventors: Nobukazu Kato, Tokyo (JP); Koji Hayashi, Tokyo (JP); Kazushi Kamata, Hirosaki-shi (JP); Michitaka Ono, Tokyo (JP)

Correspondence Address: MICHAEL BEST & FRIEDRICH LLC, 401 North Michigan Avenue, Chicago, IL, 60611, US

(21) Appl. No.: 10/090,956

(22) Filed: Mar. 5, 2002

(30) Foreign Application Priority Data
Mar. 5, 2001 (JP) 60862/2001
Mar. 9, 2001 (JP) 67706/2001

(51) Int. Cl. H01R 4/66

(52) U.S. Cl. 439/108

(57) ABSTRACT

A connector comprises a plurality of contact arrays parallel to one another. Each of the contact arrays includes two signal contacts (S) adjacent to each other and a ground contact (G) aligned with the signal contacts. In each contact array, the ground contact is located at a position corresponding to an intermediate position between two signal contacts in a next contact array.

### BACKGROUND OF THE INVENTION

This invention relates to a connector comprising a plurality of contact arrays and, in particular, to a connector suitable for high-speed differential signal transmission.

At first, high-speed differential signal transmission will be described. The high-speed differential signal transmission has two types of transmission modes, i.e., an unbalanced (single-end) type and a balanced (differential) type. The single-end type is a mode in which a high level and a low level of a digital signal are distinguished by the potential difference between a ground line and a signal line, and is generally used so far. On the other hand, the differential type is a mode in which two signal lines (+, −) are used and the high level and the low level are distinguished by the potential difference between the two signal lines. In the differential type, two signals on the two signal lines are equal in voltage level to each other and different in phase by 180° from each other. As compared with the single-end type, the differential type assures reliable transmission because noise produced in the two signal lines is canceled at the receiver input.

Besides, there is another transmission mode according to TMDS (Transition Minimized Differential Signaling). The TMDS is a standard for exchange of image data between a PC main body and a display monitor, and is a mode in which data transmission is performed by the use of two signal lines (+, −) and a single ground line.

In an existing connector comprising signal contacts and ground contacts, use is made of a structure in which the signal contacts and the ground contacts are faced to each other in a grid-like pattern or a structure in which the ground contacts are partially skipped. In the former structure, the number of contacts is increased so that miniaturization of the connector is difficult. In the latter structure, the high-frequency characteristics of the connector are considerably degraded.

At present, transmission of high-speed differential signals is required in a growing number of software applications. Under the circumstances, there is a demand for a connector having a compact size, a low price, and excellent high-frequency characteristics.

### SUMMARY OF THE INVENTION

It is therefore an object of this invention to provide a connector which is compact in size, low in price, and excellent in high-frequency characteristics.

Other objects of the present invention will become clear as the description proceeds.

According to one aspect of this invention, there is provided a connector comprising a plurality of contact arrays parallel to one another, each of the contact arrays including two signal contacts adjacent to each other and a ground contact aligned with the signal contacts, the ground contact in each contact array being disposed at a position corresponding to an intermediate position between two signal contacts adjacent to each other in a next contact array.

According to another aspect of this invention, there is provided a connector comprising first and second contact arrays parallel to each other and a third contact array between the first and the second contact arrays, each of the first and the second contact arrays including a plurality of signal contacts, the third contact array including a plurality of ground contacts, each of the ground contacts being disposed at a position corresponding to an intermediate position between every adjacent ones of the signal contacts in each of the first and the second contact arrays.

According to still another aspect of this invention, there is provided a connector for high-speed differential signal transmission, the connector comprising a plurality of + signal contacts, a plurality of − signal contacts, and a plurality of ground contacts, the contacts being arranged in a manner such that a set of each single one of the + signal contacts, each single one of the − signal contacts, and each single one of the ground contacts are located at three apexes of an isosceles triangle, respectively.

### BRIEF DESCRIPTION OF THE DRAWING

FIG. 1A is a schematic plan view of a receptacle connector according to a first embodiment of this invention,

FIG. 1B is a schematic front view of the receptacle connector of FIG. 1A;

FIG. 2A is a plan view of the receptacle connector illustrated in FIGS. 1A and 1B;

FIG. 2B is a partially-sectional side view of the receptacle connector of FIG. 2A;

FIG. 2C is a front view of the receptacle connector of FIG. 2A;

FIG. 2D is a side view of the receptacle connector of 2A;

FIG. 3A is a plan view of a plug connector adapted to be connected to the receptacle connector illustrated in FIGS. 2A to 2D;

FIG. 3B is a front view of the plug connector of FIG. 3A;

FIG. 3C is a side view of the plug connector of FIG. 3A;

FIG. 4 is a schematic plan view of a receptacle connector according to a second embodiment of this invention;

FIG. 5A is a plan view of the receptacle connector illustrated in FIG. 4;

FIG. 5B is a partially-sectional side view of the receptacle connector of FIG. 5A;

FIG. 5C is a front view of the receptacle connector of FIG. 5A;

FIG. 5D is a side view of the receptacle connector of FIG. 5A;

FIG. 6A is a plan view of a plug connector adapted to be connected to the receptacle connector illustrated in FIGS. 5A to 5D;

FIG. 6B is a front view of the plug connector of FIG. 6A;

FIG. 6C is a side view of the plug connector of FIG. 6A;

FIG. 7A is a schematic plan view of a receptacle connector according to a third embodiment of this invention;

FIG. 7B is a schematic front view of the receptacle connector of FIG. 7A;

FIG. 8A is a plan view of the receptacle connector illustrated in FIGS. 7A and 7B;

FIG. 8B is a partially-sectional side view of the receptacle connector of FIG. 8A;

FIG. 8C is a front view of the receptacle connector of FIG. 8A;

FIG. 8D is a side view of the receptacle connector of FIG. 8A;

FIG. 9 is a plan view for describing a connection pattern of transmission cables;

FIG. 10A is a plan view of a connection structure between the transmission cables and each of the receptacle connectors;

FIG. 10B is a bottom view of the connection structure of FIG. 10A;

FIG. 10C is a left side view of the connection structure of FIG. 10A;

FIG. 11A is a plan view of a modification of the connection structure illustrated in FIGS. 10A to 10C;

FIG. 11B is a sectional view taken along a line A-A in FIG. 11A;

FIGS. 12A to 12J are various views each showing a ground plate used in each of the receptacle connectors;

FIGS. 13A to 13J are various views each showing a shield plate used in each of the receptacle connectors;

FIGS. 14A to 14J are various views each showing a combination of the ground plate and the shield plate engaged with each other; and

FIG. 15 is a view for describing pitch conversion between contacts and through holes which are formed in a circuit board for receiving the contacts, respectively.

### DESCRIPTION OF THE PREFERRED EMBODIMENTS

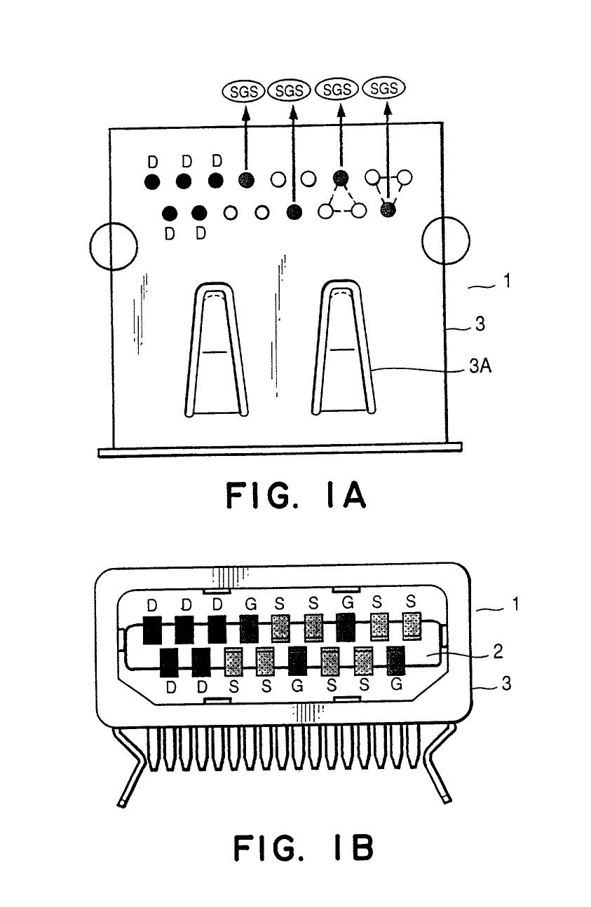

At first referring to FIGS. 1A and 1B through FIGS. 3A to 3C, description will be made of a connector according to a first embodiment of this invention.

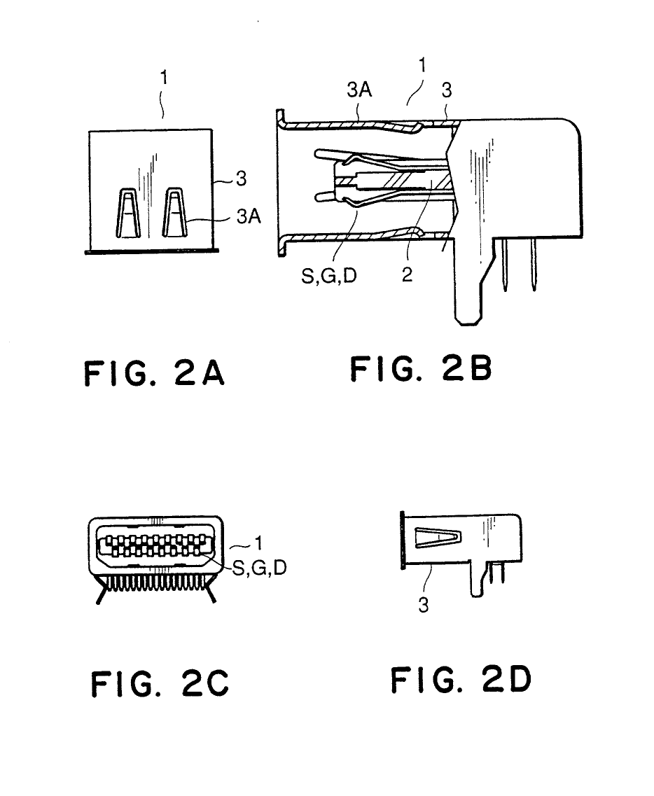

The connector illustrated in the figures is a receptacle connector 1. As illustrated in FIGS. 1B and 2A to 2D, the receptacle connector 1 comprises a plurality of signal contacts S, a plurality of ground contacts G, a plurality of ordinary (low-speed) contacts D, and an insulator 2 holding the signal contacts S, the ground contacts G, and the ordinary contacts D, and a receptacle shell 3 surrounding all of the above-mentioned components. Each pair of the signal contacts S adjacent to each other includes a + signal contact and a − signal contact.

As illustrated in FIG. 1B, the contacts of the above-mentioned three types (S, G, and D) are disposed in a specific arrangement. In an upper array, the contacts are arranged in the order of S, S, G, S, S, G, D, D, D from the right side. In a lower array, the contacts are arranged in the order of G, S, S, G, S, S, D, D from the right side. The signal contacts S, S adjacent to each other in the upper array and the ground contact G in the lower array are located at three apexes of an isosceles triangle. Likewise, the ground contact G in the upper array and the signal contacts S, S adjacent to each other in the lower array are located at three apexes of an isosceles triangle.

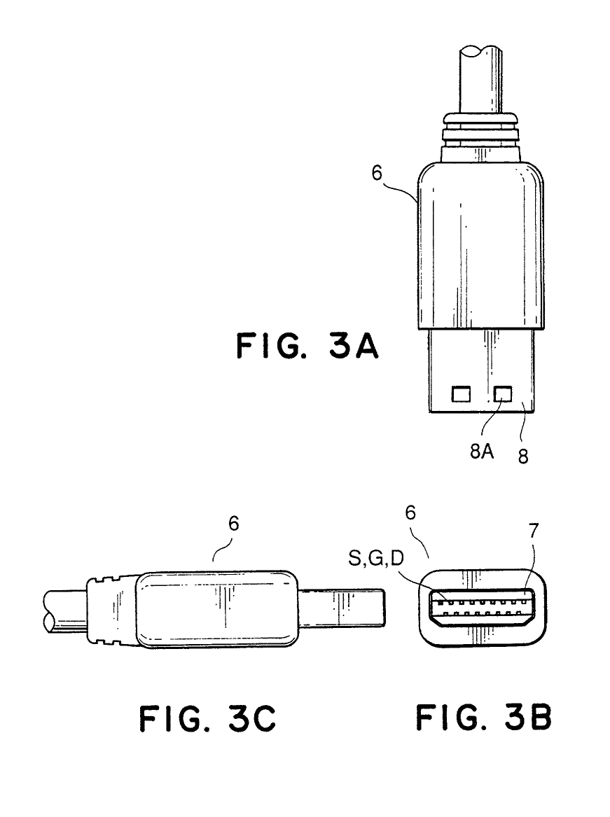

The receptacle shell 3 has an upper surface provided with a pair of springs 3A. The springs 3A are adapted to be engaged with a plug connector 6 illustrated in FIGS. 3A to 3C.

Referring to FIGS. 3A to 3C, the plug connector 6 comprises a plurality of signal contacts S, a plurality of ground contacts G, a plurality of ordinary contacts D, an insulator 7 holding the signal contacts S, the ground contacts G, and the ordinary contacts D, and a plug shell 8 surrounding all of the above-mentioned components.

The plug shell 8 has an upper surface provided with a pair of holes 8A. The holes 8A are adapted to be engaged with the springs 3A of the receptacle connector 1, respectively.

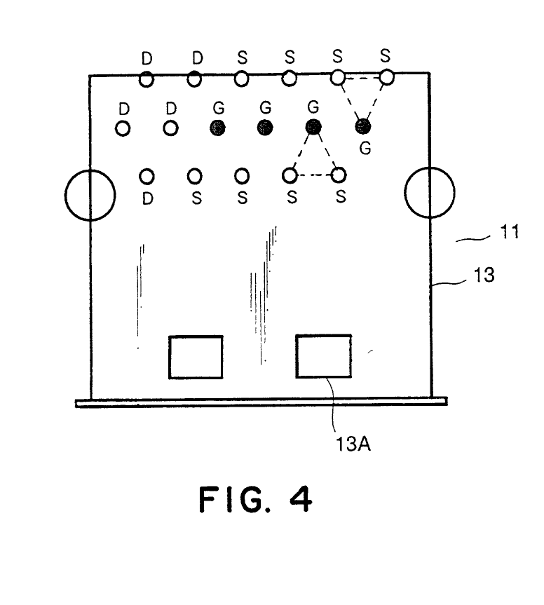

Next referring to FIGS. 4 through 6A to 6C, description will be made of a connector according to a second embodiment of this invention.

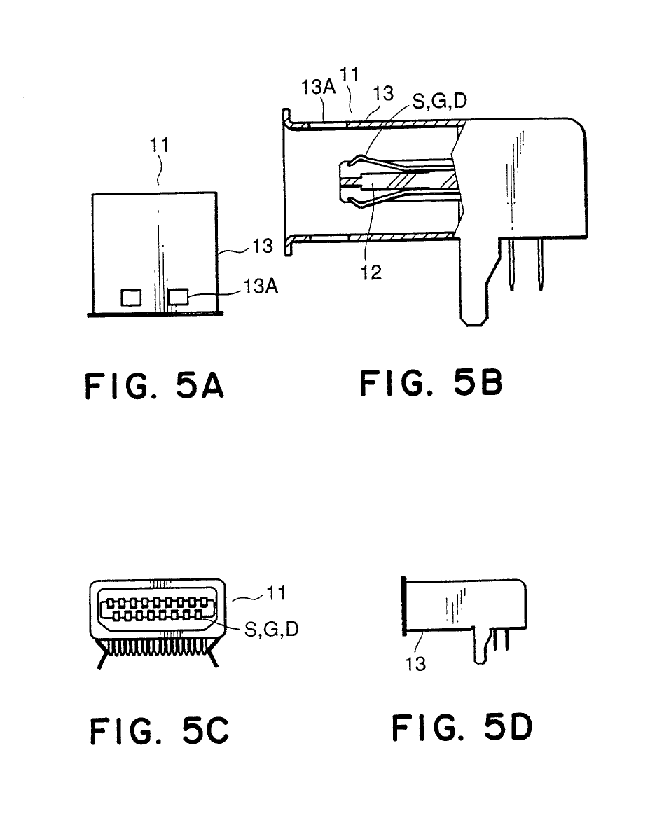

The connector illustrated in the figures is a receptacle connector 11. As illustrated in FIGS. 4 and 5A to 5D, the receptacle connector 11 comprises a plurality of signal contacts S, a plurality of ground contacts G, a plurality of ordinary contacts D, an insulator 12 holding the signal contacts S, the ground contacts G, and the ordinary contacts D, and a receptacle shell 13 surrounding all of the above-mentioned components.

Referring to FIG. 4, the contacts of the above-mentioned three types (S, G, and D) are disposed in a specific arrangement. In an upper array, the contacts are arranged in the order of S, S, S, S, D, D from the right side. In a middle array, the contacts are arranged in the order of G, G, G, G, D, D from the right side. In a lower array, the contacts are arranged in the order of S, S, S, S, D from the right side. The signal contacts S, S adjacent to each other in the upper array and the ground contact G in the middle array are located at three apexes of an isosceles triangle. Likewise, the ground contact G in the middle array and the signal contacts S, S adjacent to each other in the lower array are located at three apexes of an isosceles triangle.

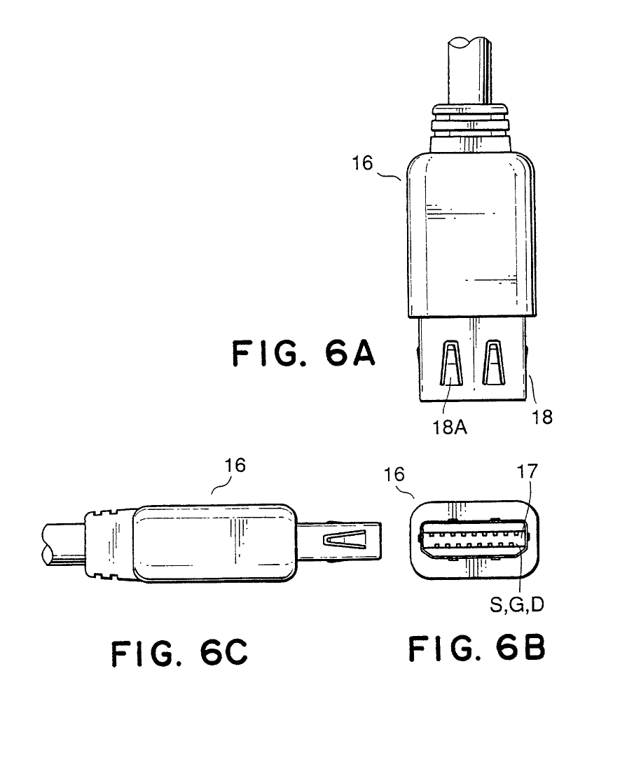

As illustrated in FIGS. 4, 5A, and 5B, the receptacle shell 13 has an upper surface provided with a pair of holes 13A. The holes 13A are adapted to be engaged with a plug connector 16 illustrated in FIGS. 6A to 6C.

Referring to FIGS. 6A to 6C, the plug connector 16 comprises a plurality of signal contacts S, a plurality of ground contacts G, a plurality or ordinary contacts D, an insulator 17 holding the signal contacts S, the ground contacts G, and the ordinary contacts D, and a plug shell 18 surrounding all of the above-mentioned components.

The plug shell 18 has an upper surface provided with a pair of springs 18A. The springs 18A are adapted to be engaged with the holes 13A of the receptacle connector 11, respectively.

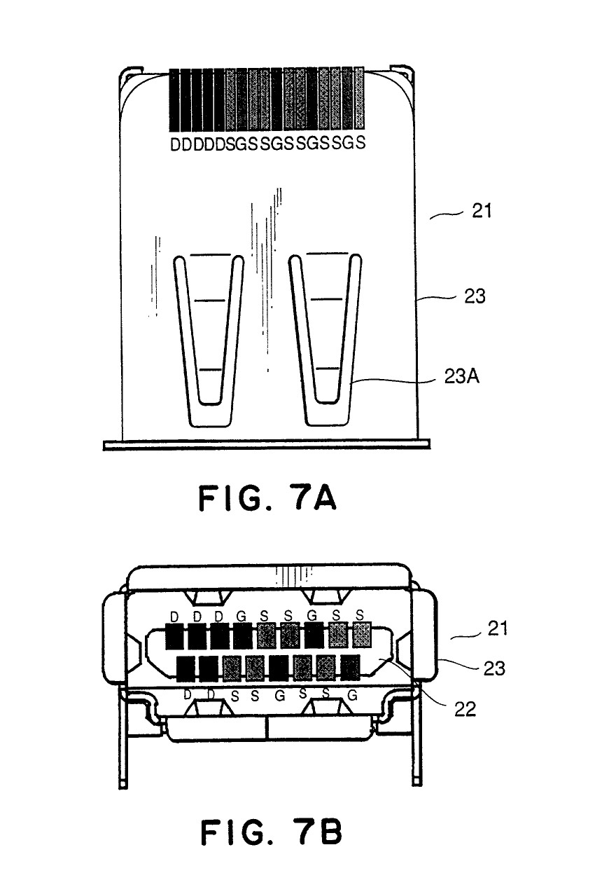

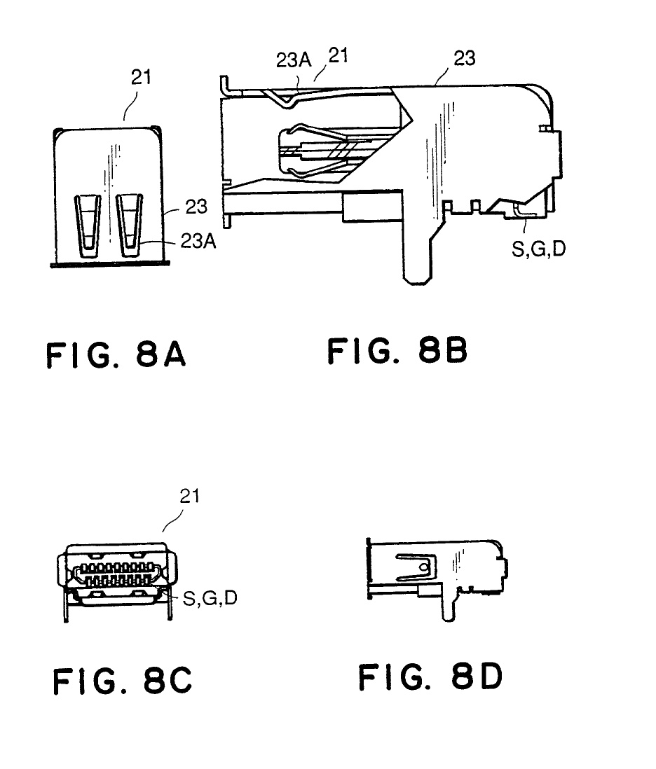

Next referring to FIGS. 7A, 7B, and 8A to 8D, description will be made of a connector according to a third embodiment of this invention.

The connector illustrated in the figures is a receptacle connector 21 of a SMT (Surface Mount) type. As illustrated in FIGS. 7B and 8A to 8D, the receptacle connector 21 comprises a plurality of signal contacts S, a plurality of ground contacts G, a plurality of ordinary contacts D, an insulator 22 holding the signal contacts S, the ground contacts G, and the ordinary contact D, and a receptacle shell 23 surrounding all of the above-mentioned components.

As illustrated in FIG. 7B, the contacts of the above-mentioned three types (S, G, and D) are disposed in a specific arrangement. In an upper array, the contacts are arranged in the order of S, S, G, S, S, G, D, D, D from the right side. In a lower array, the contacts are arranged in the order of G, S, S, G, S, S, D, D from the right side. The signal contacts S, S adjacent to each other in the upper array and the ground contact G in the lower array are located at three apexes of an isosceles triangle. Likewise, the ground contact G in the upper array and the signal contacts S, S adjacent to each other in the lower array are located at three apexes of an isosceles triangle.

As illustrated in FIG. 7A, the contacts are arranged in a single line in the order of S, G, S, S, G, S, S, G, S, S, G, S, D, D, D, D, D form the right side and exposed from the receptacle shell 23.

As illustrated in FIGS. 7A, 8A, and 8B, the receptacle shell 23 has an upper surface provided with a pair of springs 23A. The springs 23A are adapted to be engaged with a plug connector (not shown).

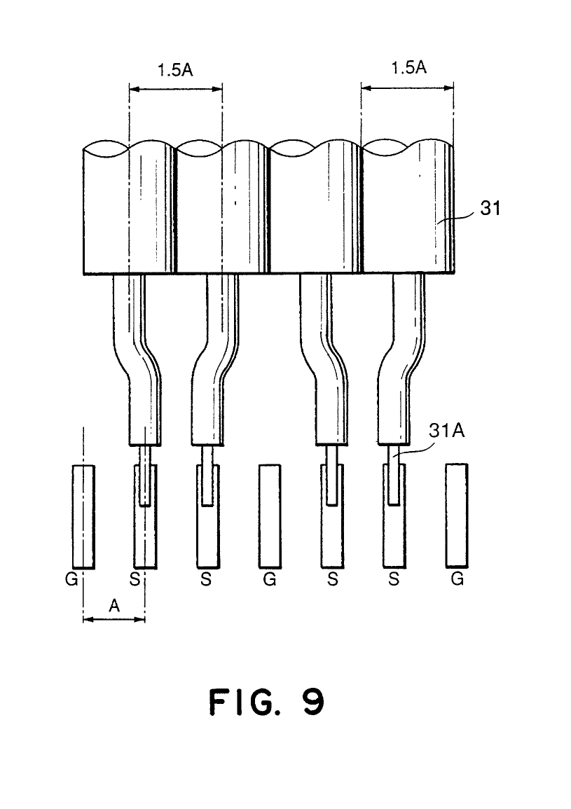

Referring to FIGS. 9 through 11A and 11B, description will be made of a connection structure of the connector in each embodiment and transmission cables.

As illustrated in FIG. 9, each transmission cable 31 has a center conductor 31A connected to each signal contact S. Each of the signal contacts S and the ground contacts G has a terminal portion to be connected to a printed board. The terminal portions are arranged in a single line in a manner such that two signal contacts S are arranged adjacent to each other and one ground contact G is arranged next. The signal contacts S and the ground contacts G are arranged at a predetermined pitch A. In this structure, a space is left in an area faced to each ground contact G. By utilizing the space, it is possible to arrange the transmission cables 31, each of which has a diameter greater than A and smaller than 1.5A, with the center conductors 31A of the transmission cable 31 connected to the signal contacts S.

In each of the above-mentioned connectors, the plug connector with the transmission cables connected thereto is fitted to the receptacle connector mounted to the printed board. Each of the signal contacts S, the ground contacts G, and the ordinary contact D may be of a surface-mount type or a through-hole type.

Referring to FIGS. 10A to 10D, the transmission cables 31 have shield portions 31B divided into upper and lower arrays. Upper-array and lower-array ground plates 32 and 33 are superposed to each other and inserted between the upper and the lower arrays of the shield portions 31B. The upper-array ground plate 32 has connecting portions 32A connected to the shield portions 31B of the upper array. The lower-array ground plate 33 has connecting portions 33A connected to the shield portions 31B of the lower array.

The upper-array and the lower-array ground plates 32 and 33 are provided with lead portions 32B and 33B to be contacted with or soldered to the ground contacts G, respectively. The upper-array and the lower-array ground plates 32 and 33 are faced to each other with the lead portions 32B and 33B alternately arranged. In this manner, the lead portions 32B and 33B can be connected to the ground contacts G arranged in a staggered fashion and located at the apexes of the isosceles triangles.

As illustrated in FIG. 10B, the lead portions 33B of the lower-array ground plate 33 are connected to the ground contacts G of the upper array while the lead portions 32B of the upper-array ground plate 32 are connected to the ground contacts G of the lower array. Alternatively, as illustrated in FIG. 10D, the lead portions 32B of the upper-array ground plate 32 are connected to the ground contacts G of the upper array while the lead portions 33B of the lower-array ground plate 33 are connected to the ground contacts G of the lower array.

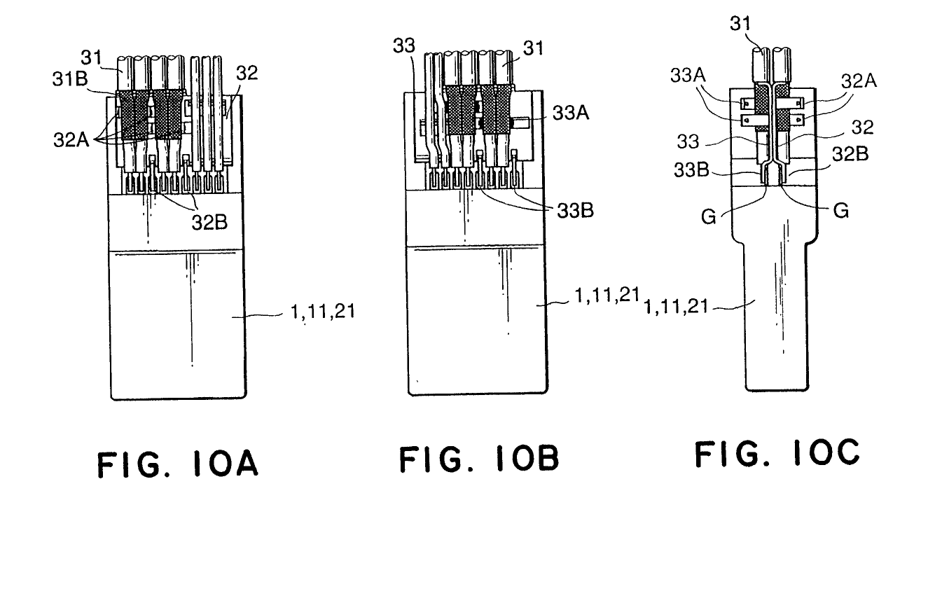

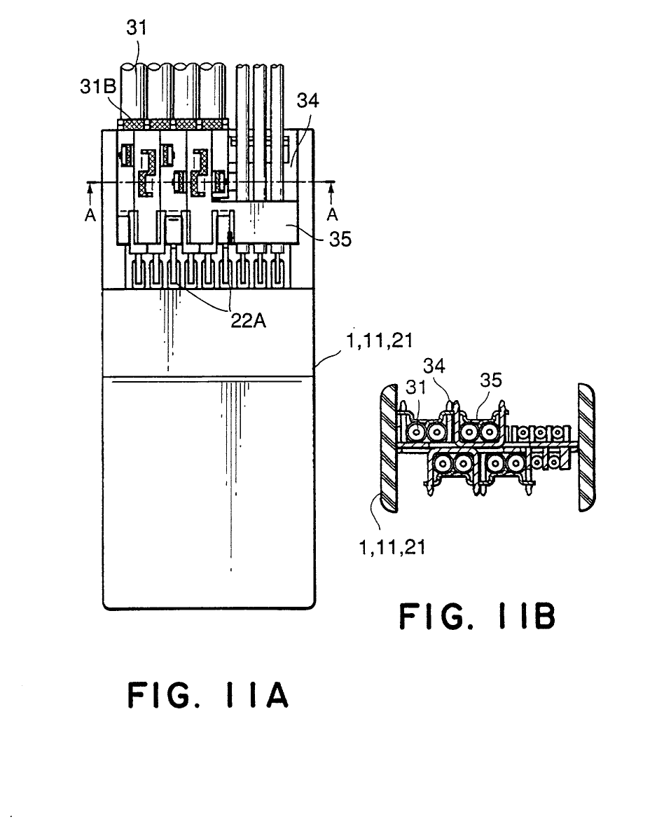

As illustrated in FIGS. 11A and 11B, the shield portion 31B of each of the transmission cables 31 on both of upper and lower sides may be surrounded by a ground plate 34 on left, right, and lower sides and by a shield plate 35 on an upper side. In this event, the shield potion 31B of the transmission cable 31 is connected to the ground plate 34 and the shield plate 35.

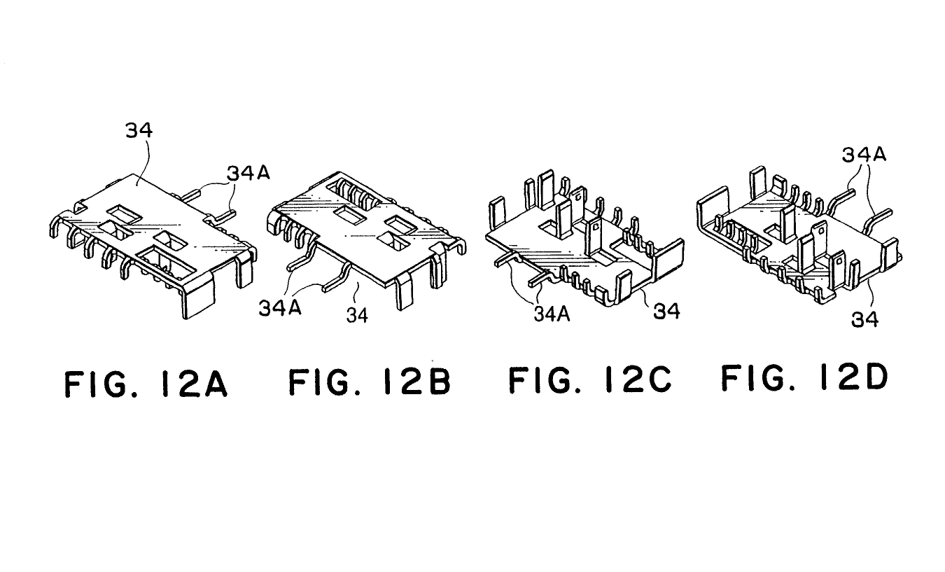

Referring to FIGS. 12A to 12J, the ground plate 34 of the connector is illustrated as seen in different directions. The ground plate 34 has one side provided with a pair of lead portions 34A which can be connected to an electric circuit formed on the circuit board.

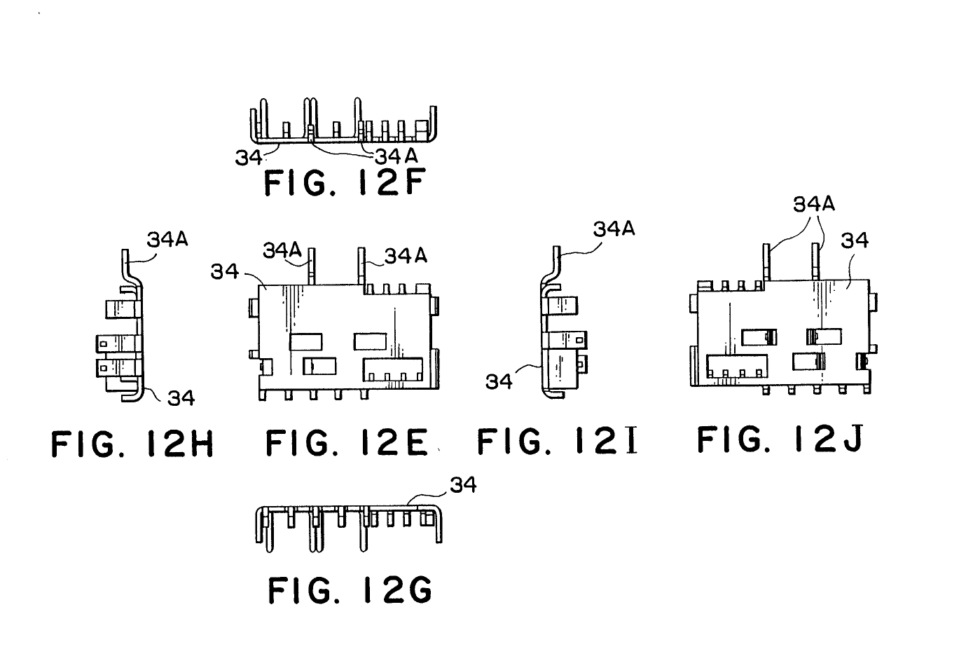

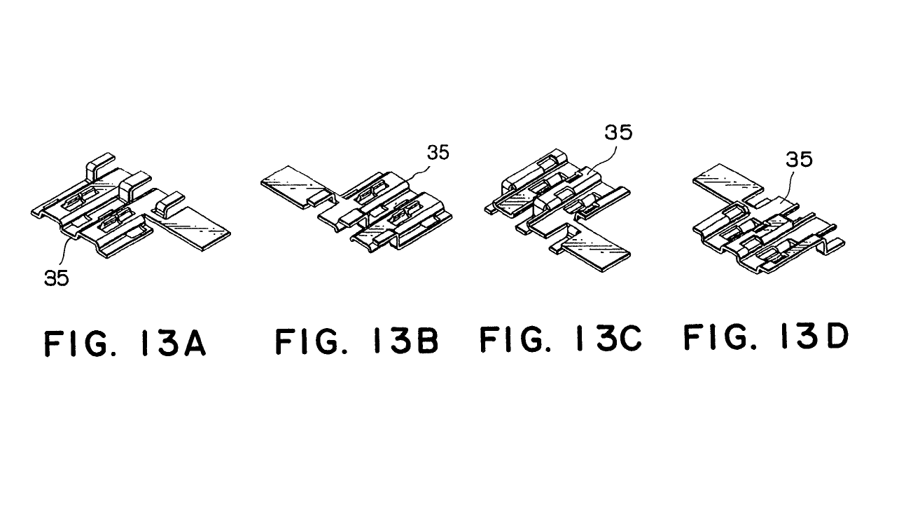

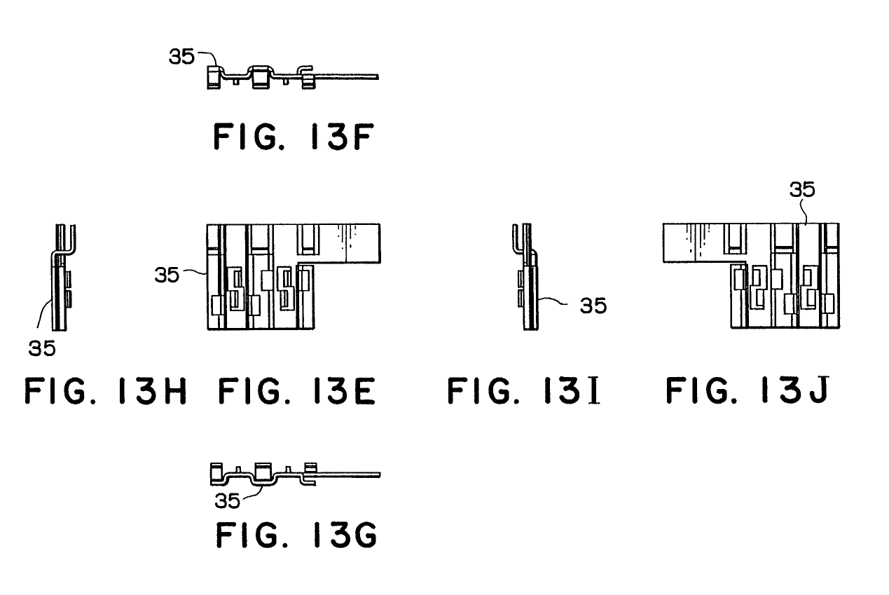

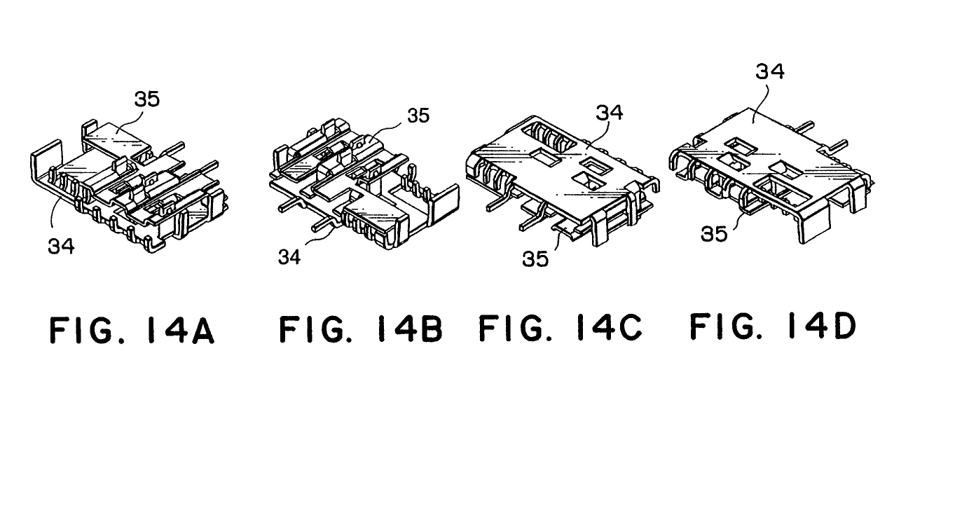

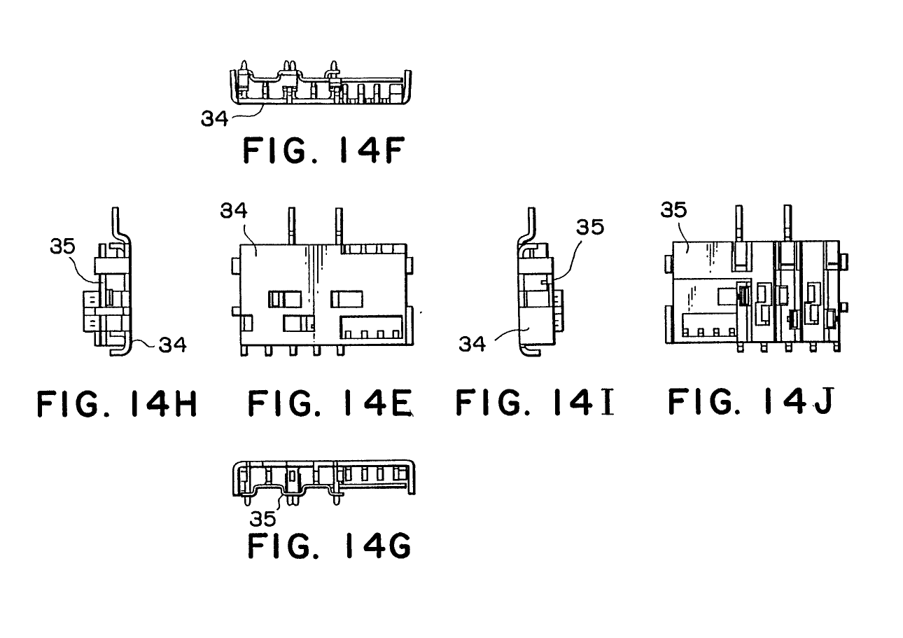

Referring to FIGS. 13A to 13J, the shield plate 35 of the connector is illustrated as seen in different directions. The shield plate 35 is engaged with the ground plate 34 to form a combination of the ground plate and the shield plate, as illustrated in FIGS. 14A to 14J.

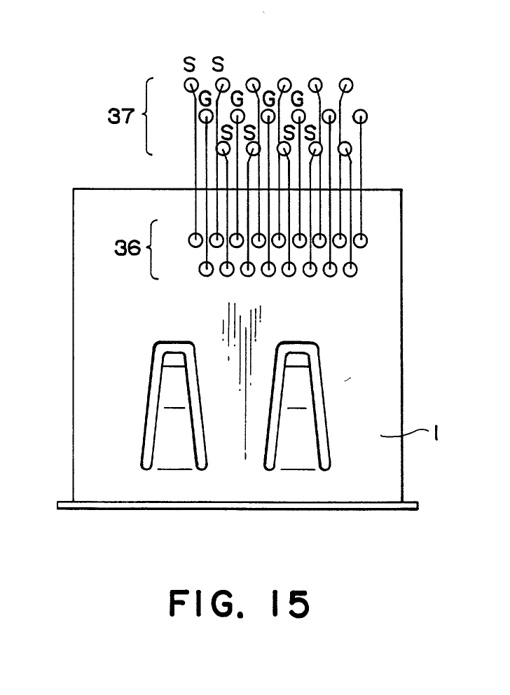

Referring to FIG. 15, the description will be made as regard a pitch of contacts 36 provided on the receptacle connector 1.

The contacts 36 are arranged in two rows on the receptacle connector 1. In this condition, the pitch is relatively small or narrow on the receptacle connector 1. The contacts 36 may be connected to an electric circuit of the circuit board by inserting the contacts 36 in through holes 37 formed in the circuit board. In this event, the through holes 37 can be arranged in three or more rows. In case where the through holes 37 are arranged in three or more rows, it becomes possible to make the pitch of the through holes 37 be relatively large or widen the pitch on the circuit board. This results in pitch conversion between the contacts 36 and the through holes 37.

What is claimed is:

1. A connector comprising a plurality of contact arrays parallel to one another, each of said contact arrays including two signal contacts adjacent to each other and a ground contact aligned with said signal contacts, said ground contact in each contact array being disposed at a position corresponding to an intermediate position between two signal contacts adjacent to each other in a next contact array.

2. The connector according to claim 1, wherein said signal contacts in one contact array and said ground contacts in another contact array adjacent to the one contact array are arranged in a staggered fashion.

3. The connector according to claim 1, wherein, in each contact array, said ground contact is arranged adjacent to said signal contact.

4. The connector according to claim 1, wherein each of said signal contacts has a signal terminal portion, each of said ground contacts having a ground terminal portion, said signal terminal portions and said ground terminal portions being arranged in a single common array.

5. The connector according to claim 4, wherein said ground terminal portion is arranged between adjacent ones of said signal terminal portions.

6. A connector comprising first and second contact arrays parallel to each other and a third contact array between said first and said second contact arrays, each of said first and said second contact arrays including a plurality of signal contacts, said third contact array including a plurality of ground contacts, each of said ground contacts being disposed at a position corresponding to an intermediate position between every adjacent ones of said signal contacts in each of said first and said second contact arrays.

7. The connector according to claim 1, wherein said ground contacts and said signal contacts in each of said first and said second contact arrays are arranged in a staggered fashion.

8. The connector according to claim 6, wherein said first, said second, and said third contact arrays are arranged in a single common plane.

9. The connector according to claim 6, wherein each of said signal contacts has a signal terminal portion, each of said ground contacts having a ground terminal portion, said signal terminal portions and said ground terminal portions being arranged in a single common array.

10. The connector according to claim 8, wherein said ground terminal portion is arranged between adjacent ones of said signal terminal portions.

11. A connector for high-speed differential signal transmission, said connector comprising:
a plurality of + signal contacts;
a plurality of − signal contacts; and
a plurality of ground contacts, said contacts being arranged in a manner such that a set of each single one of said + signal contacts, each single one of said − signal contacts, and each single one of said ground contacts are located at three apexes of an isosceles triangle, respectively.

12. The connector according to claim 11, wherein a plurality of said isosceles triangles are defined, bottom sides of said isosceles triangles being alternately arranged in a staggered fashion.

13. The connector according to claim 11, said connector being for use in high-speed differential signal transmission according to the TMDS standard.

14. The connector according to claim 11, wherein said + signal contacts, said − signal contacts, and said ground contacts are arranged at a predetermined pitch, a plurality of transmission cables being arranged utilizing spaces faced to said ground contacts, each of said transmission cables being connected to one of said + signal contact and said − signal contact.

15. The connector according to claim 14, wherein said transmission cable is one of a twisted shield cable and a coaxial cable.

16. The connector according to claim 11, further including a printed board on which said + signal contacts, said − signal contacts, and said ground contacts are arranged in a single array and surface-mounted.

17. The connector according to claim 11, wherein said ground contact is arranged between said + signal contact and said − signal contact.

18. The connector according to claim 12, further including a printed board provided with through-holes formed in three arrays at positions where said + signal contacts, said − signal contacts, and said ground contacts are mounted, said ground contacts being arranged in said through holes in the middle array.

19. The connector according to claim 15, wherein said transmission cable is said twisted shield cable, said connector comprising an upper-array ground plate and a lower-array ground plate each of which is connected to a shield portion of said twisted shield cable, each of said upper-array and said lower-array ground plates having lead portions to be contacted with or soldered to said ground contacts, said upper-array and said lower-array ground plates being faced to each other, said lead portions being alternately arranged and connected to said ground contacts located at the apexes of said isosceles triangles.

20. The connector according to claim 13, wherein said shield portion of said twisted shield cable is surrounded by said ground plate on left, right, and lower sides and by said shield plate on an upper side.
